(19) United States
(12) Patent Application Publication
(10) Pub. No.: US 2017/0249684 A1
(43) Pub. Date: Aug. 31, 2017

(54) SYSTEMS AND METHODS FOR SEARCH TERM PRIORITIZATION

(71) Applicant: eBay Inc., San Jose, CA (US)

(72) Inventor: Romualdas Maslovskis, Los Gatos, CA (US)

(73) Assignee: eBay Inc., San Jose, CA (US)

(21) Appl. No.: 15/593,545

(22) Filed: May 12, 2017

Related U.S. Application Data
(63) Continuation of application No. 14/039,144, filed on Sep. 27, 2013.

(51) Int. Cl. G06Q 30/06; G06F 17/30

(52) U.S. Cl. CPC G06Q 30/0625; G06F 17/3053; G06F 17/30867

(57) ABSTRACT

A query for product search includes multiple search terms. A priority among the multiple search terms may be determined based on past queries and the results of the past queries. Using the priority of the search terms, better and relevant search results may be returned for the query. Further, the priority of the search terms may be used to implement search term expansion, search term reduction, and search term substitution to suggest relevant alternative queries to a user to improve search results.

### BACKGROUND

Field of the Invention

The present invention generally relates to systems and methods for implementing search term prioritization.

Related Art

Internet commerce has become more prevalent and consumers increasingly rely on internet search engines to find products they wish to view or purchase. At a search engine, a consumer may enter a query related to a product that the consumer wishes to search or find. The query may include multiple terms or words. It may be difficult for the search engine to determine which of the multiple terms has priority or is more relevant than the other terms. For example, a consumer may wish to search for a white smartphone and may enter “white smartphone” as the search terms. It may be difficult for the search engine to determine that the term “smartphone” has priority and is more relevant than the word “white.” Thus, the search engine may return results of non-relevant products related to the word “white”, such as “white shovel” or “white watch”, rather than returning products related to various types of smartphones. Therefore, there is a need for a system or method that implements search term prioritization to determine priority among multiple search terms in order to return relevant search results for consumers.

### BRIEF DESCRIPTION OF THE FIGURES

FIG. 1 is block diagram of a networked system suitable for implementing a process for search term prioritization according to art embodiment.

FIG. 2 is a flowchart showing a process for determining priority of search terms according to one embodiment.

FIG. 3 is a flowchart showing a process for search term expansion according to one embodiment.

FIG. 4 is a flowchart showing a process for search term reduction according to one embodiment.

FIG. 5 is a flowchart showing a process for search term substitution according to one embodiment.

FIG. 6 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a priority among multiple search terms of a query may be determined. In particular, the priority among multiple search terms may be determined based on past queries and the results of the past queries. Thus, better and relevant search results may be returned for a query. Further, the priority of the multiple search terms may be used to implement search term expansion, search term reduction, and search term substitution. By using search term expansion, search term reduction, and search term substitution, alternative queries may be suggested to a user to improve search results.

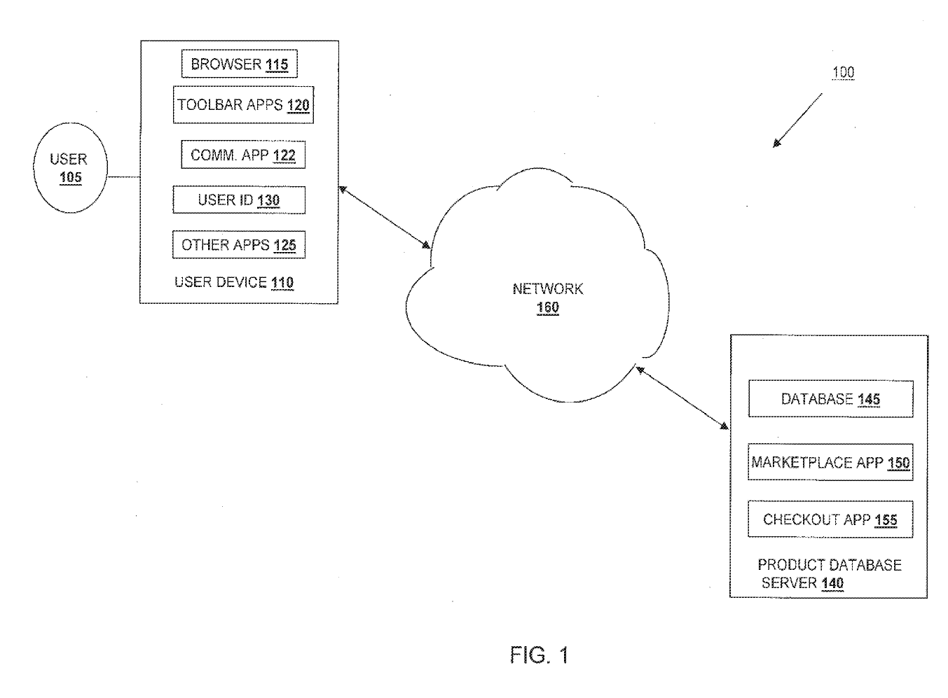

FIG. 1 is a block diagram of a networked system 100 configured to implement a process for search term prioritization in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110 and a product database server 140 in communication over a network 160. Product database server 140 may be maintained by a merchant who offers products and service for sale or by a payment service provider, such as PayPal, Inc. of San Jose, Calif. A user 105, such as a consumer, may utilize user device 110 to perform product search using product database server 140. For example, user 105 may utilize user device 110 to visit a merchant's web site provided by product database server 140 to browse for products offered by the merchant. Further, user 105 may utilize user device 110 to initiate a product query and receive results of the product query. Although only one product database server is shown, a plurality of product database servers may be implemented if the user is searching products from multiple merchants.

User device 110 and product database server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks. User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to search and browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, or make payments. Further, user device 110 may include one or more user identifiers 130 which may be implemented, for example, as operating system registry entries, cookies associated with browser application 115, identifiers associated with hardware of user device 110, or other appropriate identifiers, such as used for payment/user/device authentication. A communications application 122, with associated interfaces, enables user device 110 to communicate within system 100.

Product database server 140 may be maintained, for example, by a merchant or seller offering various products and/or services. The merchant may have a physical point-of-sale (POS) store front. Product database server 140 may be used for POS or online purchases and transactions. For example, a purchase transaction may be a donation to charity.

Product database server 140 may include a database 145 identifying available products and/or services (e.g., collectively referred to as items) which may be made available for viewing and purchase by user 105. For example, database 145 may include a product index accessible by search engines. Database 145 also may include query history storing past queries received by product databases server 140 and search results associated with the respective past queries.

Product database server 140 also may include a marketplace application 150 which may be configured to serve information over network 160 to browser 115 of user device 110. In one embodiment, user 105 may interact with marketplace, application 150 through browser applications over network 160 in order to search and view various products, food items, or services identified in database 145. User 105 may use user device 110 to send product queries to product database server 140. In response, product database server 140 may search for products and return search results to user device 110.

Product database server 140 also may include a checkout application 155 which may be configured to facilitate the purchase by user 105 of goods or services online or at a physical POS or store front. Checkout application 155 may be configured to accept payment information from or on behalf of user 105 through a payment service provider over network 160. Checkout application 155 maybe configured to receive payment via a plurality of payment methods including cash, credit cards, debit cards, checks, money orders, or the like.

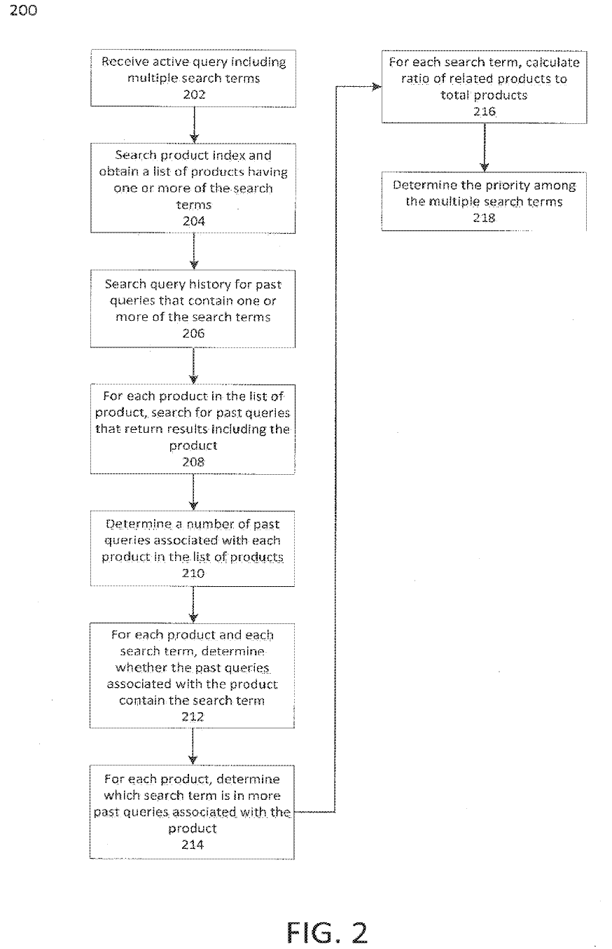

FIG. 2 is a flowchart showing a process 200 for search term prioritization according to one embodiment. At step 202, product database server 140 may receive a query, e.g., an active query, from user device 110 to search for products. The active query may include a single search term or multiple search terms. If the active query has only one search term, no search term prioritization may be needed. Assuming the active query includes multiple search terms, product database server 140 may implement search term prioritization. For example, a user may wish to view or purchase a black smartphone that has 32 GB of memory. The user may use user device 110 to access a search engine at product database server 140. The user may enter “black smartphone 32 GB” as the search terms at the search engine. The query request including the search terms may be received by product database server 140.

At step 204, product database server 140 may access a product index and search for products that match the search terms of the active query. The product index may include names and descriptions of various products. Product database server 140 may search for names or descriptions of products that match the search terms of the active query. For example, the search terms: “black smartphone 32 GB” may return products that match one or more of the search terms, such as “black watch, black laptop, and etc.” for the search term “black”, “white smartphone, yellow smartphone, smartphone case, and etc.” for the search term “smartphone”, and “iPhone 32 GB, USB drive 32 GB, laptop 32 GB, and etc.” for the search term “32 GB.”

Assuming the active query is qₐ=(t₁, . . . , t_{H}), where t's represent the search terms in the active query and II represents the number of search terms, which is equal to or greater than two (2). At step 204, the active query of the product index may return a list of products P={P₁, . . . , P_{M}} where P's represent the products in the list of products and M represents the number of products in the list of products.

If the active query does not return any results from the product index, past queries that contain one or more of the search terms of the active query may be used to determine priority. For example, product database server 140 may search for a set of past queries that contain one or more of the search terms of the active query. Then, a ratio of

$$\frac{number of queries where term is priority term}{number of queries containing term}$$

may be calculated for each search term of the active query. The search term that has greater ratio may have greater priority among the search terms of the active query.

Assuming that a list of products are found from the product index, at step 206, product database server 140 may access a query history that stores past queries and the associated query results. The past queries are queries previously submitted at the search engine by the user or other users. In particular, product database server 140 may search for past queries that contain one or more of the search terms of the active query. For example, for the active query “black smartphone 32 GB,” a set of past queries, such as “white smartphone” “32 GB iPhone” “black desktop,” and the like, may qualify as past questions that contain one or more search terms of the active query.

At step 208, for each product in the list of products P={P₁, . . . , P_{M}}, product database server 140 may search for past queries obtained from step 206 that return the product. For example, assuming that “White iPhone 32 GB” is one of the products in the list of products from step 204, product database server 140 may search for past queries obtained in step 206 that return the product “White iPhone 32 GB.” Thus, for each product Pⱼ, j=1, . . . M from product list {P₁, . . . , P_{M}}, using past queries found in step 206, a set of past queries is found for each of the product. Thus, sets of queries {Q^{t}^{₁}}ⱼ, . . . , {Q^{t}^{_{H}}}ⱼ may be created for the products in the product list, where {Q^{t}^{ᵢ}}ⱼ are the past queries created using the active query's term tᵢ, i=1, . . . , H, and returning product Pⱼ. Accordingly, for each product in the product list, a set of past queries, each of which containing at least one active term and returns the product, may be associated with the product.

At step 210, the number of past queries in the set associated with each product may be determined. Product database server 140 may count the past queries in the set of past queries associated with respective product in the product list. For example, assuming that μ is a measure, which assigns some non-negative real number to the set {Q^{t}^{ᵢ}}ⱼ, j=1, . . . M and i=1, . . . H, from sets of queries, and μ{Q^{t}^{₁}}ⱼ, . . . , μ{Q^{t}^{_{H}}}ⱼ, j=1, . . . M, are the values, which the measure assigns to each element of the set. Thus, the measure μ may be defined as the number of elements in the set {Q^{t}^{_{i}}}ⱼ, j=1, . . . M and i=1, . . . , H. For example, there may be six (6) past queries that return the product “White iPhone 32 GB,” thus, the measure of past queries associated with “White iPhone 32 GB” is six (6).

At step 212, for each product and each search term of the active query, it may be determined whether there is a past query that contains the search term and that returns the product. For example, an array or a vector may be created for each search term of the active query. The length of each vector or array may be the number of products in the list of products. In each cell of the array or vector, a value of one (1) may be entered if there is at least one past query that contains the search term corresponding to the cell and that returns the product corresponding to the cell. For example, for every search term tᵢ,i=1, . . . H of the active query qₐ, vector Yᵢ=(y₁ⁱ, . . . , y_{M}ⁱ) may be created, where yⱼⁱ=1 if {Q^{t}^{ᵢ}}ⱼ is not an empty set (contain at least one past query) and where yⱼⁱ=0 if {Q^{t}^{ᵢ}}ⱼ is an empty set (no past query), j=1, . . . , M.

For example, assuming that the active query is “black smartphone 32 GB,” for each term in the active query, a vector or an array may be created. There may be a vector for the term “black,” a vector for the term “smartphone,” and a vector for the term “32 GB.” Each vector may have a length of the number of product in the product list obtained in step 204. Assuming that there are 200 products in the product list, each of the vectors may have a length of 200 cells, one cell for each product in the product list. Each cell may correspond to one active term and one product. A value of one (1) may be entered in the cell, if there is at least one past query that contains the active term corresponding to the cell and returns the product corresponding to the cell. Otherwise, if there is no past query associated with the product, the cell associated with the product may have the value zero (0).

For example, assuming that there is a past query “Android phone 32 GB” which contains the search term “32 GB” and which returns the product “white iPhone 32 GB.” Thus, in the vector for the search term “32 GB”, the cell corresponding to the product “White iPhone 32 GB” would have the value of one (1), because there is at least one past query that contains the search term “32 GB” and returns the product of “White iPhone 32 GB.” Accordingly, for each search term of the active query and for each product, it may be determined if there is at least one past query that correspond to the search term and the product.

At step 214, for each product on the product list, it may be determined which search term of the active query has most occurrence in the past queries that associated with the product. For each product from the product list, a number of past queries associated with each search term may be determined. For example, assuming that the active query is “black smartphone 32 GB” and that “Black iPhone 32 GB” is a product in the list of products, there may be 3 past queries that return the product and contain the search term “black”, there may be 24 past queries that return the product and that contain the term “smartphone, and there may be 12 past queries that return the product and that contain the term “32 GB.” Thus, by comparing the number of related past queries, the product “White iPhone 32 GB” is most related to the search term “smartphone.” As such, the product “White iPhone 32 GB” may be assigned to the search term “smartphone.” The same comparison may be executed for all products of the product list and each products may be assigned to one search term.

For example, vector Sᵢ−(s₁ⁱ, . . . , s_{M}ⁱ), i=1, . . . , H may be created. For each element Pⱼ, from result set P={P₁, . . . , P_{M}}, find active query's term tᵢ* for which μ{Q^{t}si*}ⱼ=maxᵢ μ{Q^{t}^{ᵢ}}ⱼ, and assign sᵢⁱ* and sⱼⁱ=0, i=1, . . . , H,j=1, . . . , M and i≠i*. If there are more than one term tₖ, k ∈ K, K ⊂ {1, . . . , H} for which μ{Q^{t}^{ₖ}}ⱼ=maxᵢ μ{Q^{t}^{ᵢ}}ⱼ, i=1, . . . , H, then sᵢ^{k}=1, k ∈ K, and sⱼⁱ=0, i=1, . . . , H and i ∉ K. Thus, each product is assigned to or associated with a search term of the active query based on the number of past queries associated with each product and search term.

At step 216, for each search term, a ratio between the number of associated products and a number of total products may be determined. From step 214, a number of products that are associated or assigned to each search term may be determined by counting or totaling the products associated with the respective search terms. A ratio of the number of associated products and the number of total products may then be calculated for each search term. For every search term tᵢ, i=1, . . . , H of active query

$${q}_{a} , {R}_{i} = \frac{{\sum }_{j = 1}^{M} {s}_{j}^{i}}{M} , i = 1 , … , H$$

may be calculated. For example, assuming the number of products in the product list is 350 and the search terms of the active query are “black smartphone 32 GB,” the search term “black” may have 100 associated products and have a ratio of 100/350, the search term “smartphone” may have 200 associated products and have a ratio of 200/350, and the term “32 GB” may have 50 associated products and have a ratio of 50/350.

At step 217, the priority of the search terms may be determined. For example, based on the ratio calculated in step 216, the priority among the search terms may be determined. In the above example, the search term “smartphone” has the greatest ratio (200/350) and may be determined to be the priority search term. In one embodiment, a search term may have priority when the ratio of the search term is greater than a predetermined threshold, such as 0.6. For example, search term tₚ, p ∈ {1, . . . , H} may have priority if it satisfies conditions Rₚ=maxᵢ Rᵢ, i=1, . . . , H and

$$\frac{{\sum }_{j = 1}^{M} {y}_{j}^{p}}{M} > {Y}^{opt} ,$$

where Y^{opt} is some predefined number, for example 0.6, if more than one search terms satisfy the condition, then more than one search terms may have priority.

By using the above process, the priority among search terms in a query may be determined to facilitate and improve search results in a product search. In particular, past queries and the results from the past queries may be used to determine the priority of the search terms in an active query. Accordingly, during a product search, the search engine may give more weight to search terms with higher priority to return more relevant search results.

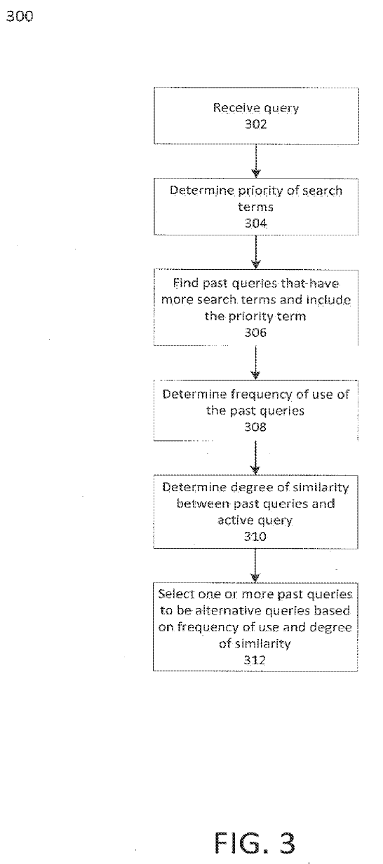

FIG. 3 is a flowchart showing a process for search term expansion according to one embodiment. At step 302, a query may be received from a user. For example, product database server 140 may receive a query, e.g., an active query, from user device 110 to search for products. At step 304, the priority of the search terms of the active query may be determined. For example, the priority of the search terms may be determined by using the above process 200. In one embodiment, the priority of the search terms may be indicated by the user.

At step 306, product database server 140 may access query history to search for past queries that include the priority search term and that have a number of search terms greater than the active query. For example, active query's qₐ expansion set Qₐ^{exp} may be created. Expansion set elements may be past queries with number of terms greater than the active query and containing active query's qₐ priority term tᵢ*, Qₐ^{exp} [symbol] qᵢ=(t₁, . . . , tᵢ*, . . . , t_{Z}), where Z>H. For example, assuming that the active query qₐ=“black smartphone 32 GB” and priority term is “smartphone”, expansion set Qₐ^{exp} may include past queries containing the term “smartphone” and having more than three (3) terms, such as “apple smartphone white 32 GB”, “android smartphone white unlocked” and etc.

At step 308, the frequency of use of the past queries may be determined. For example, for each qₗ ∈ Qₐ^{exp} prior probabilities estimates

$$\hat{p} ( q = {q}_{l} ) = \frac{{n}_{i}}{{\sum }_{{q}_{t} ∈ {Q}_{a}^{expansion }} {n}_{t} }$$

may be calculated, where nᵢ is the frequency of query qₗ usage and Σ_{q}_{ₜ}_{∈Q}_{ₐ}_{^{expansion}} nₜ is the frequency of queries from Qₐ^{exp} usage.

At step 310, the degree of similarity between the past queries and the active query may be determined using cosine similarity calculation. For example, likelihood P(qₐ|q=qₜ) using function f(qₐ, qₜ) may be modeled. Cosine similarity may be used for relation between active query qₐ and past queries qₜ ∈ Qₐ^{exp} modeling. Queries qₐ and qₜ may be represented as a vector of 0's and/or 1's. Assuming that I={I₁, . . . , I_{V}} is vector, Iⱼ ∈ {0,1}, j=1, . . . V and V represents the total number of products in the store. If search query returns product j when Iⱼ=1, otherwise Iⱼ=0. Cosine similarity between queries qₐ and qᵢ ∈ Qₐ^{exp} may be calculated as follows:

$$f ( {q}_{a} , {q}_{l} ) = sim ( {q}_{a} , {q}_{l} ) = \frac{{\sum }_{j = 1}^{V} {I}_{j}^{a} * {I}_{j}^{l}}{\sqrt{{\sum }_{j = 1}^{V} {( {I}_{j}^{a} )}^{2}} * \sqrt{{\sum }_{j = 1}^{V} {( {I}_{j}^{l} )}^{2}}} ,$$

where I^{a}={I₁^{a}, . . . , I_{V}^{a}} associated query qₐ and I^{l}={I₁^{l}, . . . , I_{V}^{l}} associated with qᵢ, qₗ ∈ Qₙ^{exp}. Thus, the degree of similarity between the active queries and the past queries may be calculated based on the number of common products each of the queries return.

At step 312, one or more past queries may be selected to be alternative queries based on the calculated frequency of use and the degree of similarity of the past queries. For example, for every past queries qₗ ∈ Qₐ^{exp}, posterior probability estimate \hat{P}(qₜ|qₐ)=\hat{P}(q=qₜ)* f(qₐ, qₜ) may be calculated. The queries Qₐ^{exp} may be sorted according to their \hat{P}(qₜ|qₐ). Thus, the top past queries may be suggested to the user as alternative queries for use. In one embodiment, the factors of the frequency of use and the degree of similarity may be weighted differently when sorting the past queries. For example, in certain circumstances, the degree of similarity may weigh more than the frequency of usage for determining alternative queries.

Thus, by the above process 300, alternative queries with greater search terms may be determined based on the frequency of use and degree of similarity of past queries to the active query. Accordingly, relevant alternative queries with additional search terms may be suggested to the user to improve search results.

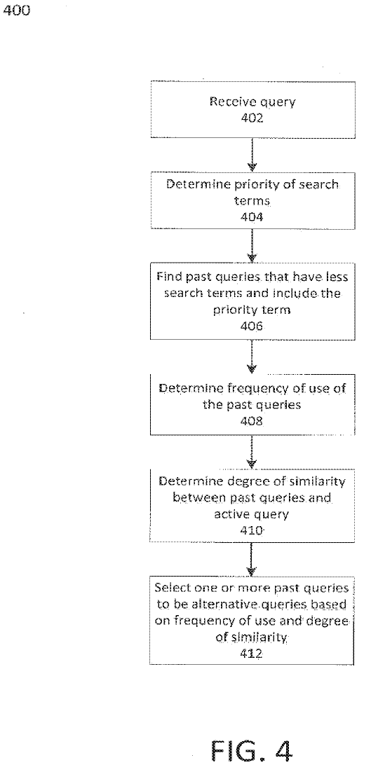

FIG. 4 is a flowchart showing a process for search term reduction according to one embodiment. At step 402, a query may be received from a user. For example, product database server 140 may receive a query, e.g., an active query, from user device 110 to search for products. At step 404, the priority of the search terms of the active query may be determined. For example, the priority of the search terms may be determined by using the above process 200. In one embodiment, the priority of the search terms may be indicated by the user.

At step 406, product database server 140 may access query history to search for past queries that include the priority search term and that have a number of search terms less than the active query. For example, active query qₐ's reduction set Qₐ^{red} may be created. Reduction set elements may be past queries with number of terms less than the active query and containing active query's qₐ priority term tᵢ*, Qₐ^{red} [symbol] qₗ=(t₁, . . . , tᵢ*, . . . , t_{Z}), where Z<H. For example, assuming that the active query qₐ is “black smartphone 32 GB” and priority term is “smartphone”, expansion set Qₐ^{exp} may include queries containing the term “smartphone” and having less than three (3) terms “apple smartphone”, “android smartphone” and etc.

At step 408, the frequency of use of the past queries may be determined. For example, for each qₗ∈ qₐ^{red}, prior probabilities estimates

$$\hat{p} ( q = {q}_{l} ) = \frac{{n}_{l}}{{\sum }_{{q}_{t} ∈ {Q}_{a}^{red}} {n}_{t}} ,$$

where nₜ is the frequency of query qₜ usage and Σ_{q}_{ₜ}_{∈Q}_{ₐ}_{^{red}} nₜ is the frequency of queries from Qₐ^{red} usage.

At step 410, the degree of similarity between the past queries and the active query may be determined using cosine similarity calculation. For example, likelihood P(qₐ|q=qₗ) using function f(qₐ, qᵢ) may be modeled. Cosine similarity may be used for relations between active query and past queries modeling. Queries qₐ and qᵢ may be represented as a vector of 0's and/or 1's. Assuming that I={I₁, . . . , I_{V}} is vector, Iⱼ ∈{0,1}, j=1, . . . V and V represents the total number of products in the product index. If search query returns product j when Iⱼ=1, otherwise Iⱼ=0. Cosine similarity between the active query and the past queries may be calculated as

$$f ( {q}_{a} , {q}_{l} ) = sim ( {q}_{a} , {q}_{l} ) = \frac{{\sum }_{j = 1}^{V} {I}_{j}^{a} * {I}_{j}^{l}}{\sqrt{{\sum }_{j = 1}^{V} {( {I}_{j}^{a} )}^{2}} * \sqrt{{\sum }_{j = 1}^{V} {( {I}_{j}^{l} )}^{2}}} , {q}_{l} ∈ {Q}_{a}^{red}$$

Thus, the degree of similarity between the active queries and the past queries may be calculated based on the number of common products the active and the past queries return.

At step 412, one or more past queries may be selected to be alternative queries based on the calculated frequency of use and the degree of similarity of the past queries. For example, for every past query qₜ ∈ Qₐ^{red}, posterior probability estimate \hat{P}(qₜ|qₐ)=\hat{P}(q=qₜ)* f(qₐ, qₜ) may be calculated. The queries Qₐ^{red} may be sorted according to their \hat{P}(qₜ|qₐ). Thus, the top past queries may be suggested to the user as alternative queries for use. In one embodiment, the factors of the frequency of use and the degree of similarity may be weighted differently when sorting the past queries. For example, in certain circumstances, the degree of similarity may weigh more than the frequency of usage for determining alternative queries.

Thus, by the above process 400, alternative queries with less search terms may be determined based on the frequency of use and degree of similarity of past queries to the active query. Accordingly, relevant alternative queries with reduced search terms may be suggested to the user to improve search results.

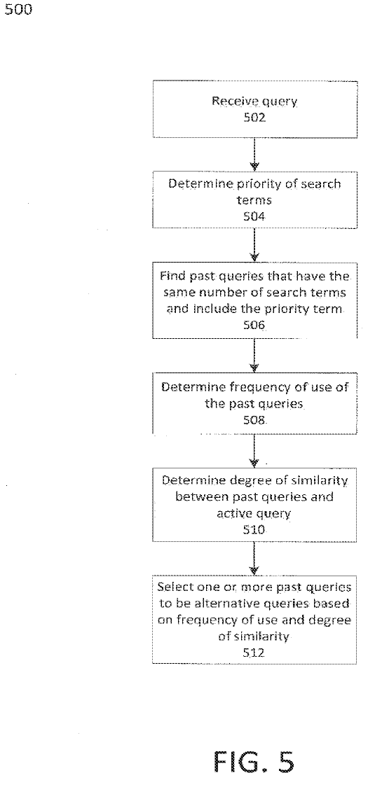

FIG. 5 is a flowchart showing a process for search term substitution according to one embodiment. At step 502, a query may be received from a user. For example, product database server 140 may receive a query, e.g., an active query, from user device 110 to search for products. At step 504, the priority of the search terms of the active query may be determined. For example, the priority of the search terms may be determined by using the above process 200. In one embodiment, the priority of the search terms may be indicated by the user.

At step 506, product database server 140 may access query history to search for past queries that include the priority search term and that have a number of search terms the same as the active query. For example, active query qₐ's substitution set may be created. Substitution set elements may be past queries with number of terms the same as the active query and containing active query's qₐ priority term tᵢ*, Qₐ^{sub} [symbol] qₜ=(t₁, . . . , tᵢ*, . . . , t_{Z}), where Z=H. For example, assuming that the active query qₐ is “black smartphone 32 GB” and priority term is “smartphone”, substitution set Qₐ^{sub} may include queries containing the term “smartphone” and having three (3) terms: “apple smartphone 32 GB”, “android smartphone 16 GB” and etc.

At step 508, the frequency of use of the past queries may be determined. For example, for each qₗ ∈ Qₐ^{sub} prior probabilities estimates

$$\hat{p} ( q = {q}_{l} ) = \frac{{n}_{l}}{{\sum }_{{q}_{t} ∈ {Q}_{a}^{sub}} {n}_{t}}$$

may be calculated, where nₗ is the frequency of query qₜ was used and Σ_{q}_{ₜ}_{∈Q}_{ₐ}_{^{sub}} nₜ is the frequency of queries from Qₐ^{sub} were used (except query qₗ).

At step 510, the degree of similarity between the past queries and the active query may be determined using cosine similarity calculation. For example, likelihood P(qₐ|q=qₗ) using function f(qₐ,qₗ) may be modeled. Cosine similarity may be used for relations between active query and past queries modeling. Queries qₐ and qₗ may be represented as a vector of 0's and/or 1's. Assuming that I={I₁, . . . , I_{V}} is vector, Iⱼ ∈ {0,1}, j=1, . . . V and V represents the total number of products in the product index. If search query returns product j when Iⱼ=1, otherwise Iⱼ=0. Cosine similarity between the active query and the past queries may be calculated as

$$f ( {q}_{a} , {q}_{l} ) = sim ( {q}_{a} , {q}_{l} ) = \frac{{\sum }_{j = 1}^{V} {I}_{j}^{a} * {I}_{j}^{l}}{\sqrt{{\sum }_{j = 1}^{V} {( {I}_{j}^{a} )}^{2}} * \sqrt{{\sum }_{j = 1}^{V} {( {I}_{j}^{l} )}^{2}}} , {q}_{l} ∈ {Q}_{a}^{sub} .$$

Thus, the degree of similarity between the active queries and the past queries may be calculated based on the number of common products the active and the past queries return.

At step 512, one or more past queries may be selected to be alternative queries based on the calculated frequency of use and the degree of similarity of the past queries. For example. For every query qₜ ∈ Qₐ^{sub} calculate posterior probability estimate \hat{P}(qₜ|qₐ)=\hat{P}(q=qₗ)*f(qₐ, qₗ) may be calculated. The queries Qₐ^{sub} may be sorted according to their \hat{P}(qₜ|qₐ). Thus, the top past queries may be suggested to the user as alternative queries for use. In one embodiment, the factors of the frequency of use and the degree of similarity may be weighted differently when sorting the past queries. For example, in certain circumstances, the degree of similarity may weigh more than the frequency of usage for determining alternative queries.

Thus, by the above process 500, alternative queries with the same number of search terms as the active query may be determined based on the frequency of use and degree of similarity of past queries to the active query. Accordingly, relevant alternative queries with substitute search terms may be suggested to the user to improve search results.

The above processes 200-500 may be executed at product database server 140. In one embodiment, one or more steps of processes 200-500 may be executed by user device 110. In another embodiment, one or more steps of processes 200-500 may be executed by another processor or server configured to facilitate product search and have access to the product index and the query history.

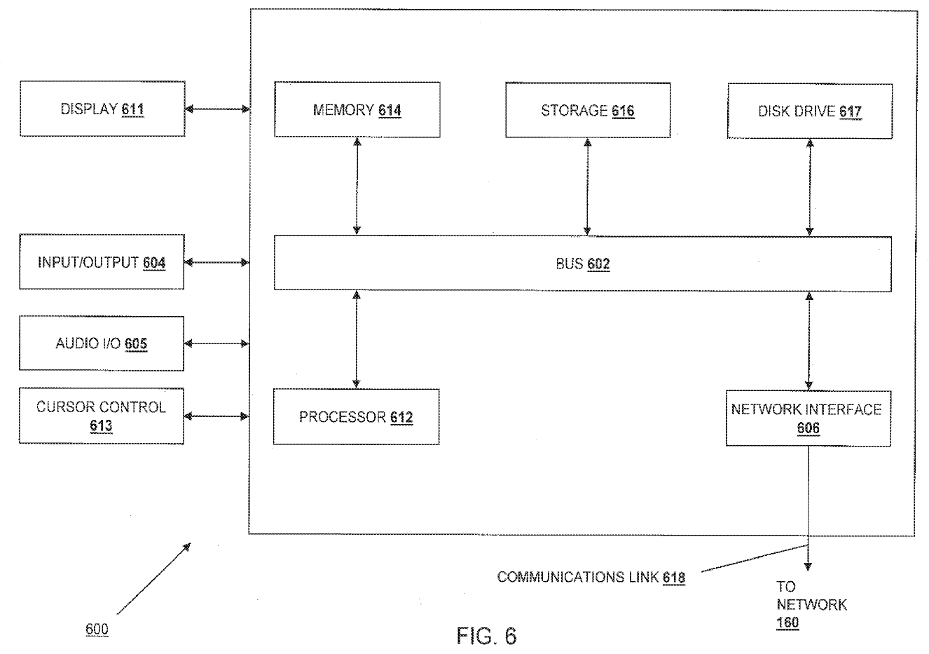

FIG. 6 is a block diagram of a computer system 600 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant may utilize a network computing device (e.g., a network server) capable of communicating with the network. It should be appreciated that each of the devices utilized by users and merchants may be implemented as computer system 600 in a manner as follows.

Computer system 600 may include a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another user device, a merchant server, or a payment provider server via network 160. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via a communication link 618. Processor 612 may also control transmission of information, such as cookies or IP addresses, to other devices.

Components of computer system 600 also may include a system memory component 614 (e.g., RAM), a static storage component 616 (e.g., ROM), and/or a disk drive 617. Computer system 600 may perform specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media may include optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for search term prioritization, the system comprising:
a memory storing a product index and a query history; and
one or more processors in communication with the memory and adapted to:
receive an active query including at least a first search term and a second search term;
query the product index to obtain a list of products matching at least one of the first and the second search terms;
for each respective product in the list of products, determine, from the query history, a first set of past queries associated with the respective product, wherein each query in the first set of past queries associated with the respective product includes the first search term and returns the respective product;
for each respective product in the list of products, determine, from the query history, a second set of past queries associated with the respective product, wherein each query in the second set of past queries associated with the respective product includes the second search term and returns the respective product;
for each respective product in the list of products, associate the respective product with one of the first and the second search terms based on a number of past queries in the first set of past queries and a number of past queries in the second set of past queries associated with the respective product; and
determine a priority between the first and the second search terms based on a number of products associated with the first search term and a number of products associated with the second search term.

2. The system of claim 1, wherein the respective product is associated with the first search term when a number of the past queries in the first set associated with the respective product is greater than a number of the past queries in the second set associated with the respective product.

3. The system of claim 1, wherein the first search term has priority over the second search term when the first search term is associated with a greater number of products than a number of products associated with the second search term.

4. The system of claim 1, wherein the one or more processors is farther adapted to:
for each of the first and the second search terms, calculate a ratio between a number of associated products and a total number of products in the list of products; and
determine priority of the first and the second search terms based on whether the ratio is greater than a predetermined value.

5. The system of claim 4, wherein both the first and the second search terms have priority when both of the ratios calculated for the first and the second search terms are greater than the predetermined value.

6. The system of claim 1, wherein the one or more processors is further adapted to:
query the query history for a particular set of past queries that contain at least one of the first and the second search terms that have priority;
determine a frequency of use for each past query in the particular set of past queries;
determine a degree of similarity between the active query and each past query in the particular set of past queries; and
determine an alternative set of queries from the particular set of past queries based on the frequency of use and the degree of similarity of each past query in the particular set of past queries.

7. The system of claim 6, wherein the particular set of past queries includes past queries that have more number of search terms than that of the active query.

8. The system of claim 6, wherein the particular set of past queries includes past queries that have less number of search terms than that of the active query.

9. The system of claim 6, wherein the particular set of past queries includes past queries that have the same number of search terms as that of the active query.

10. The system of claim 1,
wherein the active query includes a third search term and
wherein the one or more processors is further adapted to:
for each respective product in the list of products, determine, from the query history, a third set of past queries associated with the respective product, wherein each query in the third set of past queries associated with the respective product includes the third search term and returns the respective product;
for each respective product in the list of products, associate the respective product with one of the first, the second, and the third search terms based on a number of past queries in the first set of past queries, a number of past queries in the second set of past queries, and a number of past queries in the third set of past queries associated with the respective product; and
determine priority among the first, the second, and the third search terms based on a number of products associated with the first search term, a number of products associated with the second search term, and a number of products associated with the third search term.

11. A method for search term prioritization, the method comprising:
receiving an active query including at least a first search term and a second search term;
querying a product index to obtain a list of products matching at least one of the first and the second search terms;
for each respective product in the list of products, determining, from a query history, a first set of past queries associated with the respective product, wherein each query in the first set of past queries associated with the respective product includes the first search term and returns the respective product;
for each respective product in the list of products, determining, from the query history, a second set of past queries associated with the respective product, wherein each query in the second set of past queries associated with the respective product includes the second search term and returns the respective product;
for each respective product in the list of products, associating the respective product with one of the first and the second search terms based on a number of past queries in the first set of past queries and a number of past queries in the second set of past queries associated with the respective product; and
determining a priority between the first and the second search terms based on a number of products associated with the first search term and a number of products associated with the second search term.

12. The method of claim 11, wherein the respective product is associated with the first search term when a number of the past queries in the first set associated with the respective product is greater than a number of the past queries in the second set associated with the respective product.

13. The method of claim 11, wherein the first search term has priority over the second search term when the first search term is associated with a greater number of products than a number of products associated with the second search term.

14. The method of claim 11, further comprising:
for each of the first and the second search terms, calculating a ratio between a number of associated products and a total number of products in the list of products; and
determining priority of the first and the second search terms based on whether the ratio is greater than a predetermined value.

15. The method of claim 14, wherein both the first and the second search terms have priority when both of the ratios calculated for the first and the second search terms are greater than the predetermined value.

16. The method of claim 11 further comprising:
querying the query history for a particular set of past queries that contain at least one of the first and the second search terms that have priority;
determining a frequency of use for each past query in the particular set of past queries;
determining a degree of similarity between the active query and each past query in the particular set of past queries; and
determining an alternative set of queries from the particular set of past queries based on the frequency of use and the degree of similarity of each past query in the particular set of past queries.

17. The method of claim 16, wherein the particular set of past queries includes past queries that have more number of search terms than that of the active query.

18. The method of claim 16, wherein the particular set of past queries includes past queries that have less number of search terms than that of the active query.

19. The method of claim 16, wherein the particular set of past queries includes past queries that have the same number of search terms as that of the active query.

20. The method of claim 11,
wherein the active query includes a third search term, and
wherein the method further comprising:
for each respective product in the list of products, determining, from the query history, a third set of past queries associated with the respective product, wherein each query in the third set of past queries associated with the respective product includes the third search term and returns the respective product;
for each respective product in the list of products, associating the respective product with one of the first, the second, and the third search terms based on a number of past queries in the first set of past queries, a number of past queries in the second set of past queries, and a number of past queries in the third set of past queries associated with the respective product; and
determining priority among the first, the second, and the third search terms based on a number of products associated with the first search term, a number of products associated with the second search term, and a number of products associated with the third search term.
